(19) United States
(12) Patent Application Publication
(10) Pub. No.: US 2009/0015536 A1
(43) Pub. Date: Jan. 15, 2009

(54) LIQUID CRYSTAL DISPLAY APPARATUS

(75) Inventors: Masahiko Takeoka, Nara (JP); Seiji Kawaguchi, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 12/166,820

(22) Filed: Jul. 2, 2008

(30) Foreign Application Priority Data
Jul. 6, 2007 (JP) 2007-178488
Sep. 5, 2007 (JP) 2007-230544
May 20, 2008 (JP) 2008-132362
May 20, 2008 (JP) 2008-132365

(51) Int. Cl. G09G 3/36

(52) U.S. Cl. 345/99; 345/102

(57) ABSTRACT

A display area in a liquid crystal display apparatus is divided into five blocks extending in the lateral direction, is controlled to have a black writing period, a video writing period and a video holding period in each block in this order, and is controlled to delay the video writing period of the k^{th} block in comparison with the video writing period in the (k−1)^{th} block by a predetermined time period.

### CROSS-REFERENCE TO RELATED APPLICATIONS

This application is based upon and claims the benefit of priority from (1) the Japanese Patent Application No. 2007-178488, filed on Jul. 6, 2007, (2) the Japanese Patent Application No. 2007-230544, filed on Sep. 5, 2007, (3) the Japanese Patent Application No. 2008-132362, filed on May 20, 2008 and (4) the Japanese Patent Application No. 2008-132365, filed on May 20, 2008; the entire contents of which are incorporated herein by reference.

### TECHNICAL FIELD

The present invention relates to a liquid crystal display apparatus.

### BACKGROUND OF THE INVENTION

In the related art, in the liquid crystal display apparatus with a rapid response property for improving an animation visibility, it is considered to improve the contrast by applying a backlight luminance control. In order to do so, the gamma characteristic is switched so as to maintain the gamma characteristic to be displayed in an ideal state even when the range of the luminance is switched by varying the luminance of the backlight according to the video.

As an example of the liquid crystal display apparatus characterized by the quick response as described above, there is an OCB-type liquid crystal display apparatus, which is mounted in a liquid crystal TV or a liquid crystal monitor or the like (For example, see JP-A-2004-185027). For the OCB-type liquid crystal display apparatus, so-called “flashingless driving method” is proposed for preventing reverse transfer from a spray alignment to a bend alignment. The flashingless driving method includes a black writing period in which black video signals are written in respective pixels in one frame period, a video writing period in which video signals are written in the respective pixels, and a video holding period in which the video signals written in the respective pixels are held and the backlight is illuminated in this period. By using such flashingless driving method, a brilliant image is displayed without the occurrence of the reverse transfer.

In the liquid crystal display apparatus as described above, when it is determined that the video is bright, the luminance of the backlight is increased and the gamma characteristic is switched to the direction in which the inclination from dark to bright is laid down, and when it is determined that the video is dark, the luminance of the backlight is lowered and the gamma characteristic is switched to the direction in which the inclination from dark to bright is raised, so that the video is expressed with the wider range of gamma characteristics.

As examples of the method of determining the brightness of the video as described above, there is a method of determining by a tone level obtained by averaging the tones of the respective pixels in one video frame and a method of making a histogram of tones of the respective pixels and determining a tone level which exists most therein.

The luminance of the backlight is varied according to the tone level determined by these methods of determination. Proposed methods of varying the luminance of the backlight are a method of varying the pulse width on the basis of a PWM control, a method of varying the voltage or the electric current, for example.

By switching the luminance of the backlight in association with the video as described above, the luminance displayed from liquid crystal is varied in a wide range from a maximum tone and a maximum backlight luminance to a minimum tone and a minimum backlight luminance, so that the contrast is significantly improved.

As the luminance of the backlight is lowered other than the cases under the conditions that the backlight is to be illuminated at the maximum luminance, the power consumption is reduced in comparison with the backlight which is constantly illuminated as in the related art.

However, the timing to output the video and the timing to switch the luminance of the backlight is determined by taking a video of a certain frame timing (for example, it is referred to as a “a^{th} frame period”), then carrying out an averaging process or a histogram process as described above in the (a+1)^{th} frame period, and then calculating the luminance of the backlight or the gamma characteristics.

Therefore, the timing when the luminance of the backlight is switched actually is in the (a+2)^{th} frame period, so that control is carried out two frames later. Accordingly, there arises a problem such that the outputted video and the luminance of the backlight are not matched, and hence abnormal video such as flickering due to the luminance of the backlight or the delay in luminance change is viewed.

Therefore, video signals entered from a video signal source are taken in the a^{th} frame period and stored in a frame memory. Then, the luminance of the backlight and the gamma characteristics are calculated in the (a+1)^{th} frame period, and then the luminance of the backlight and the gamma characteristics are switched in the (a+2)^{th} frame period, and video stored in the frame memory is outputted.

By using such frame memory as described above, the luminance of the backlight and the gamma may be controlled according to the video.

However, in this method, the frame memory for storing video of an amount corresponding to at least three frames is necessary as described above, and hence there arises a problem such that the cost is increased and a space for mounting a circuit substrate connected to the liquid crystal panel is increased.

### BRIEF SUMMARY OF THE INVENTION

In view of such problems as described above, it is an object of the invention to provide a liquid crystal display apparatus in which the memory capacity is reduced and video is displayed brilliantly.

According to embodiments of the invention, there is provided a liquid crystal display apparatus including:

a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;

a backlight illuminating the liquid crystal panel;

a source driver outputting video signals and non-video signals to the respective signal lines;

a gate driver outputting gate signals to the respective scanning lines;

a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order; and

a second control unit controlling illumination and extinction of the backlight, and illuminating the backlight for each block and during the video holding period in each block.

An embodiment of the invention is a liquid crystal display apparatus including:

a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;

a backlight illuminating the liquid crystal panel;

a source driver outputting video signals and non-video signals to the respective signal lines;

a gate driver outputting gate signals to the respective scanning lines;

a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order and controlling each block to have the non-video signal writing period, the video writing period and the video holding period in this order; and

a second control unit controlling illumination and extinction of the backlight.

An embodiment of the invention is a liquid crystal display apparatus including:

a liquid crystal panel having m signal lines extending in the vertical direction, n scanning lines extending in the lateral direction and a plurality of pixels arranged in a matrix pattern in a display area which is divided into blocks from a first block to an L^{th} block extending in the lateral direction;

a backlight illuminating the liquid crystal panel;

a source driver outputting video signals and non-video signals to the respective signal lines;

a gate driver outputting gate signals to the respective scanning lines;

a first control unit controlling the non-video signals to have a non-video signal writing period in which the non-video signals are written in the respective pixels, a video writing period in which the video signals are written in the respective pixels, and a video holding period in which the video signals written in the respective pixels are held in sequence in one frame period in this order; and

a second control unit controlling illumination and extinction of the backlight,

in which the first control unit

(1) controls the each block to have the non-video signal writing period, the video writing period and the video holding period in this order, and

(2) controls the video writing period of the k^{th} block (where 1<k<L) to be delayed with respect to the video writing period of the (k−1)^{th} block by a predetermined time period.

An embodiment of the invention is a liquid crystal display apparatus including:

a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;

a backlight illuminating the liquid crystal panel and including a light source for the each block;

a source driver outputting video signals and non-video signals to the respective signal lines;

a gate driver outputting pulsed gate signals to the respective scanning lines;

a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order, the first control unit (1) controling the each block to have the non-video signal writing period, the video writing period and the video holding period in this order, and (2) controlling the video writing period of the k^{th} block (where 1<k≦L) to be delayed with respect to the video writing period of the (k−1)^{th} block by a predetermined time period; and

a second control unit controlling illumination and extinction of the backlight, the second control unit (1) correcting the luminance of the light source of the k^{th} block within a predetermined range of the luminance of the light source of the (k−1)^{th} block and (2) illuminating the respective light sources at corrected luminance only in the video holding period of each block and extinguishes the same during other periods.

An embodiment of the invention is a liquid crystal display apparatus including:

a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;

a backlight illuminating the liquid crystal panel and including a light source for each block;

a source driver outputting video signals and non-video signals to the respective signal lines;

a gate driver outputting pulsed gate signals to the respective scanning lines;

a first control controlling, in each block, the non-video signals to have a non-video signal writing period in which the non-video signals are written in the respective pixels, a video writing period in which the video signals are written in the respective pixels, and a video holding period in which the video signals written in the respective pixels are held in sequence in one frame period in this order; and

a second control unit controlling illumination and extinction of the backlight, the second control unit (1) calculating the luminance of the each light source for each frame period on the basis of the video signals, (2) correcting the luminance of the each light source in the current frame period into a luminance included in a predetermined range of an average value of the luminance of the each light source in one frame period before the current frame period, and (3) illuminating the each light source at the corrected luminance only in the video holding period of each block and extinguishes the same in other periods.

From the configuration shown above, the invention only requires to prepare memories for storing the video signals for each block so that the capacity of memory is reduced in comparison with the related art.

### BRIEF DESCRIPTION OF THE DRAWINGS

FIG. 1 is a block diagram of a liquid crystal display apparatus according to a first embodiment

FIG. 2 is a block diagram of a controller.

FIG. 3A is an plan view of a backlight.

FIG. 3B is an side view of the backlight.

FIG. 4 is a timing chart showing a flow of process for each frame unit.

FIG. 5A is an plan view of the backlight according to a second embodiment.

FIG. 5B is an side view of the backlight according to the second embodiment.

FIG. 6 is a timing chart showing a flow of the process in one frame unit.

FIG. 7 is an drawing illustrating variation in luminance in respective blocks in one frame according to a third embodiment.

FIG. 8 is a flowchart showing a method of controlling the luminance according to the third embodiment.

FIG. 9 is an drawing showing luminance values in respective blocks in respective frames according to a fourth embodiment.

### DETAILED DESCRIPTION OF THE INVENTION

Referring now to the drawings, an OCB-type liquid crystal display apparatus according to embodiments of the invention will be described.

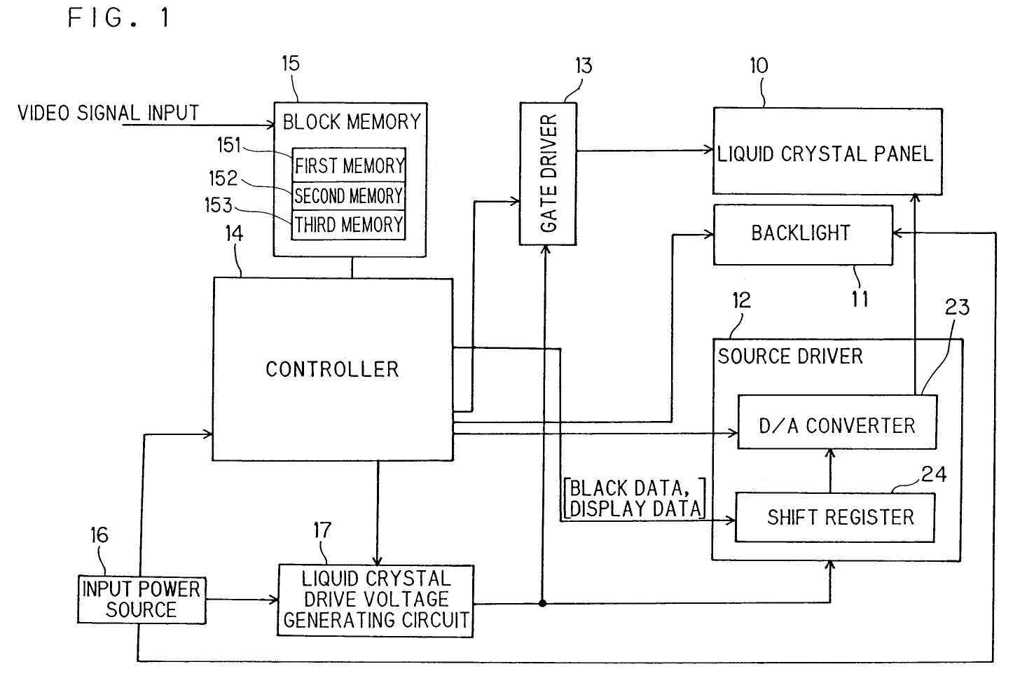

Referring now to FIG. 1 to FIG. 4, an OCB-type liquid crystal display apparatus according to a first embodiment of the invention will be described.

Referring now to FIG. 1, a configuration of the liquid crystal display apparatus according to the first embodiment will be described. FIG. 1 is a block diagram showing the configuration of the OCB-type liquid crystal display apparatus.

The OCB-type liquid crystal display apparatus includes, for example, a liquid crystal panel 10 of a size from 7 to 9 inches, a backlight 11, a source driver 12, a gate driver 13, a controller 14, a block memory 15, an input power source 16 and a liquid crystal drive voltage generating circuit 17.

The liquid crystal panel 10 includes an array substrate and an opposed substrate, and the array substrate includes signal lines and scanning lines arranged so as to be orthogonal to each other and TFTs (thin film transistors) at intersections thereof, and liquid crystal of OCB mode is interposed between the array substrate and the opposed substrate. It is assumed that the liquid crystal panel 10 in the first embodiment includes the signal lines from first to m^{th} lines formed in the vertical direction, and the scanning lines from first to n^{th} lines formed in the lateral direction. For example, in the case of WVGA (Wide Video Graphics Array), since there are 800 (×RGB)×480 lines, the value “n” is 480 (n=480).

The backlight 11 is arranged on the back surface of the liquid crystal panel 10. The backlight 11 will be described later.

The block memory 15 stores data of entered video signal temporarily. The block memory 15 will also be described later.

The input power source 16 supplies an electric power to the backlight 11, the controller 14 and the liquid crystal drive voltage generating circuit 17, and the liquid crystal drive voltage generating circuit 17 adjusts a voltage to be supplied to the source driver 12 and the gate driver 13 according to the timing to display the display data on the liquid crystal panel 10.

The gate driver 13 supplies gate signals to the scanning lines of the liquid crystal panel 10, and the source driver 12 supplies voltages corresponding to the video signals to the signal lines of the liquid crystal panel 10.

The source driver 12 includes a D/A converter 23 and a shift register 24.

The controller 14 will be described later.

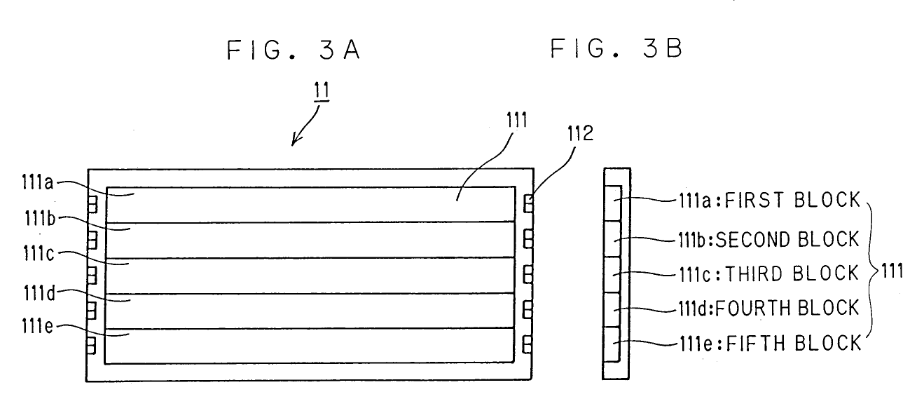

Referring now to FIG. 3, a configuration of the backlight 11 will be described.

The backlight 11 in the first embodiment includes a light guide panel 111 and ten LEDs 112.

In FIG. 3, five LEDs 112 are embedded along a left end portion and a right end portion of the light guide panel 111 at predetermined pitches, respectively. The LEDs 112 arranged on the left and right end portions are provided at opposed positions.

With the arrangement of the LEDs 112 as described above, the light guide panel 111 is divided into blocks from a first block 111a to a fifth block 111e extending in the lateral direction.

When the two LEDs 112 corresponding to the first block 111a are illuminated, only the first block lila of the light guide panel 111 is illuminated, and a video of the liquid crystal panel 10 corresponding to the illuminated first block 111a is displayed.

In order to divide the backlight 11 into five blocks as described above, the display area to be displayed thereby is also divided into five blocks. For example, since the first embodiment is WVGA as described above, the following relation is established.

The first block is a display area corresponding to scanning lines from the first scanning line to the 96^{th} scanning line.

The second block is a display area corresponding to scanning lines from the 97^{th} scanning line to the 192^{nd} scanning line.

The third block is a display area corresponding to scanning lines from the 193^{rd} scanning line to the 288^{th} scanning line.

The fourth block is a display area corresponding to scanning lines from the 289^{th} scanning line to the 384^{th} scanning line.

The fifth block is a display area corresponding to scanning lines from 385^{th} scanning line to the 480^{th} scanning line.

In this method of dividing the block, the 480 scanning lines are divided evenly into five parts. However, the invention is not limited thereto, and may be divided into blocks having scanning lines of 100, 100, 80, 100, 100, respectively, or the scanning lines at the boundaries may be overlapped.

The block memory 15 is not used for storing video signals for one frame period as in the related art, but includes three memories, and the video signals for one block are stored in each memory. To store the video signals for one block here means to store video signals for the block-to-block display as described above.

In the description shown below, the period for storing the video for one block and displaying the same is referred to as one block period.

Referring now to FIG. 1, the display operation of the controller 14 in the liquid crystal display apparatus will be described.

The video signals as RGB data are temporarily accumulated in the block memory 15.

The controller 14 reads data of blocks before current blocks accumulated in the black memory 15 and carries out gamma correction process for the video signals thereof. The correction process will be described later. Then, the controller 14 transfers the data for display after having applied with the correction process to the shift register 24 of the source driver 12 according to a start pulse by the amount corresponding to one pixel row.

The controller 14 transfers the data for the black video for preventing reverse transfer to the shift register 24 according to the start pulse by the amount corresponding to one pixel row.

Then, the controller 14 outputs a load pulse to the D/A converter 23 of the source driver 12. The D/A converter 23 acquires data stored in the shift register 24 simultaneously at the timing when the load pulse is entered by the amount corresponding to one pixel row, carries out D/A conversion, and outputs the voltage corresponding to the respective display data to the signal lines of the liquid crystal panel 10.

At this time, the controller 14 controls the output timing of the pulsed gate signals to be outputted from the gate driver 13 to the respective scanning lines, causes the respective LEDs 112 of the backlight 11 to illuminate at the timing when the respective TFTs of the liquid crystal panel 10 respond the display data, and causes the display data to be displayed on the liquid crystal panel 10.

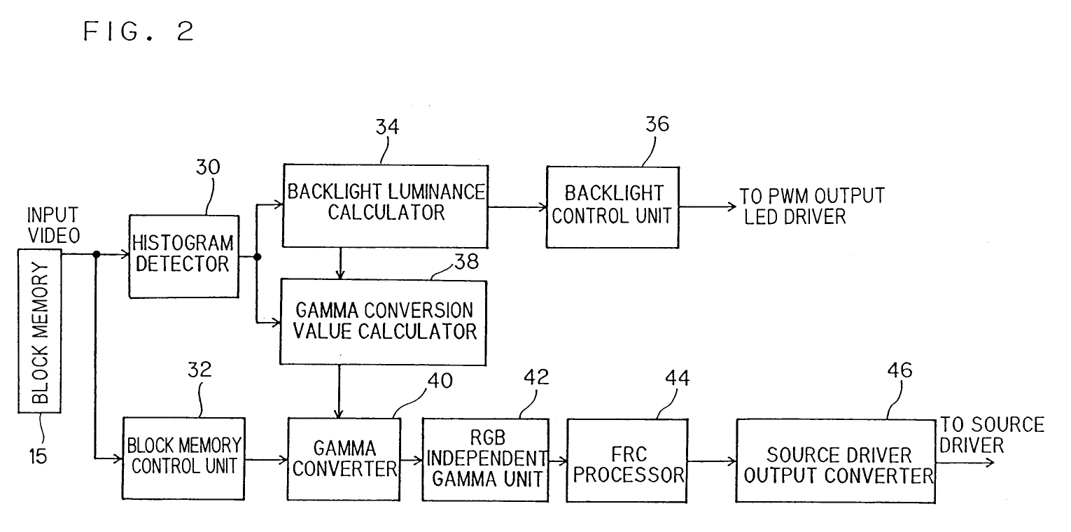

Referring now to FIG. 2, the detailed configuration of the signal processing carried out by the controller 14 will be described. FIG. 2 is a block diagram relating to the signal processing carried out by the controller 14.

As shown in FIG. 2, the controller 14 includes a histogram detector 30, a block memory control unit 32, a backlight luminance calculator 34, a backlight control unit 36, a gamma converting value calculator 38, a gamma converter 40, an RGB independent gamma unit 42, an FRC processor 44 and a source driver output converter 46.

The histogram detector 30 counts the number of pixels included in the respective tone ranges divided in advance, for example, into ten ranges, on the basis of the entered video signals in the entered video signals corresponding to one frame period and generates a histogram which is in one-to-one correspondence with the number of pixels (the number of pixels is an example of frequency of the pixels) included in the respective tone ranges. The detected histogram is outputted to the backlight luminance calculator 34 and the gamma converting value calculator 38.

The frame memory control unit 32 stores video signals for the one frame period in the block memory 15.

The backlight luminance calculator 34 calculates the luminance of the backlight 11 on the basis of the histogram entered from the histogram detector 30. For example, when the frequency of the low tone ranges is high in the histogram, the backlight luminance calculator 34 controls the luminance of the backlight 11 so as to follow the high-frequency tone ranges, that is, to a luminance lower than the normal luminance, and when the frequency of the high tone ranges is high, it controls the luminance of the backlight 11 to a high luminance. The calculated backlight luminance is outputted to the backlight control unit 36.

The backlight control unit 36 adjusts the luminance of the backlight 11 on the basis of the entered backlight luminance. The adjustment is carried out by using a PWM (Pulse Width Modulation) Control Method for modulating the luminance by switching the periods of light emission and non-light emission rapidly. Therefore, the backlight control unit 36 generates the PWM control signals on the basis of the backlight luminance signals and outputs the same to the backlight 11. The adjustment of the luminance of the backlight 11 may be achieved by controlling the amount of electrical current by itself instead of the method shown above.

The gamma converting value calculator 38 calculates a gamma converting value for correcting the gamma value of the entered video signals from the histogram and the backlight luminance.

The gamma converter 40 changes the gamma of the video signals on the basis of the video signals entered from the frame memory control unit 32 and the gamma converting values entered from the gamma converting value calculator 38. For example, when the luminance of the backlight 11 is controlled to be lower than the normal luminance on the basis of the histogram, the luminance is lowered in comparison with the essential tone luminance. Therefore, the video signals are converted so as to achieve a higher tone than the essential tone. This conversion converts the gamma to be closer to an ideal gamma curve, for example, rises to the 2.2^{th} power gamma curve.

The RGB independent gamma unit 42 corrects the gamma values of the video signals independently of R, G and B on the basis of the changed gamma conversion. This correction is applied effectively when it is preferable to set the gamma independently of R, G and B as in the case of the liquid crystal of the OCB type, for example.

The FRC processor 44 carries out an FRC (Frame Rate Control) processing for the video signals of R, G and B, respectively. The FRC processor 44 is used, for example, when carrying out the tone display corresponding to 10-bit using the 8-bit source driver, for example, in 10-bit input video signals.

The source driver output converter 46 outputs the RGB video signals having subjected to the FRC process to the source driver 12.

Subsequently, a flashingless driving method according to the liquid crystal display apparatus in the first embodiment will be described.

The flashingless driving method includes a black writing period in which black video signals as the non-video signals are written during, for example, a first ¼ frame period, a video writing period in which the video signals are written during the subsequent ¼ frame period, and a video holding period in which the written video signals are held for 2/4 frame period in this order in the one frame period. Then, the LEDs 112 corresponding to the backlight 11 are illuminated in the video holding period to display the video.

With this flashingless driving method, a black video is written at the beginning of the one frame period, so that the reverse transfer from the bend alignment to a spray alignment is prevented and a brilliant image is obtained. Since the backlight 11 is illuminated during the video holding period, flicker or the like does not occur in the video.

The term “black video signals” means signals corresponding to the black insertion, and they are not displayed as a video since the backlight 11 is not illuminated in the black writing period. The black color in the black video signals is not limited to black of tone “0”, and may be of a tone (color) close to the tone “0”.

It is also possible to use the non-video signals having a higher voltage value than the black video signals instead of the black video signals. In this case, the display is gray, but little bad influence is exerted to the contrast by keeping the backlight 11 extinguished, and prevention of the reverse transfer is effectively achieved. For example, by the ratio of insertion of the non-video signals may further be shortened by using the non-video signals corresponding to the higher voltage value than the black video signals. Accordingly, a high display luminance may be obtained also under a high temperature environment which accelerates the probability of occurrence of the reverse transfer. The ratio of insertion of the non-video signals may be adapted to be changed as needed on the basis of the environmental temperature.

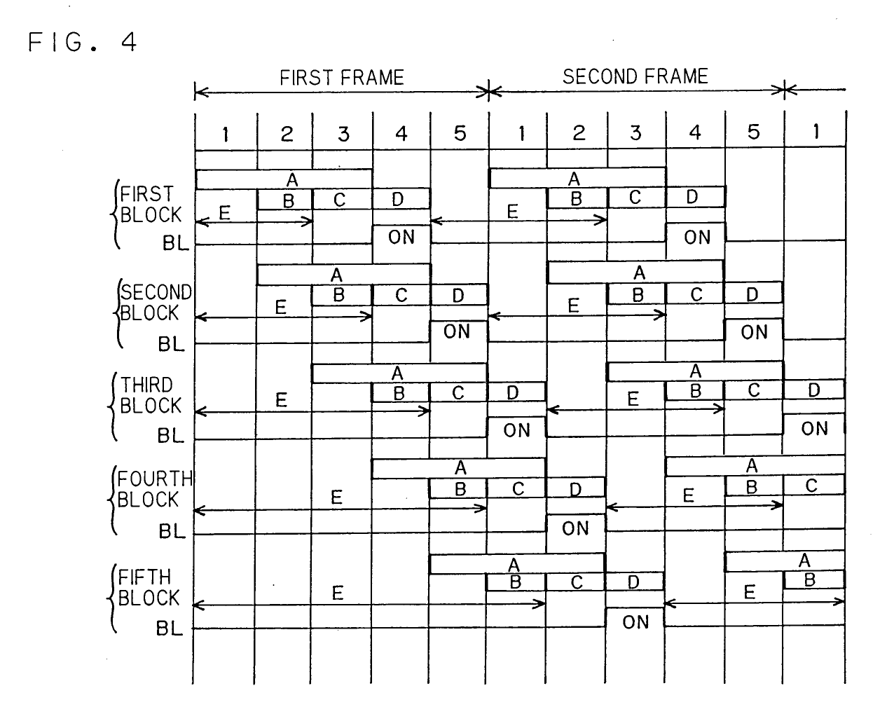

Referring now to FIG. 4, the detailed driving method of the liquid crystal display apparatus will be described.

FIG. 4 is an explanatory drawing illustrating a detailed display method, and showing a temporal flow of the process in the respective frame units. The lateral axis represents the flow of signals in each frame period and the one frame period is divided into five divided periods for explanation. The lateral axis represents the flow of signals in each block and the state of illumination (ON) or extinction of the LEDs 112 of the backlight 11, which is shown by “BL” in FIG. 4.

Reference sign A designates taking of the video signals and a storage period of the respective memories 151 to 153 in the frame memory 15. Reference sign B designates a data calculating period used for backlight luminance calculating process and the gamma value calculating process described above. Reference sign C designates the video writing period. Reference sign D designates the video holding period. Reference sign E designates the black writing period.

The first block will now be described.

In a first divided period in the first frame period, the video signals displayed in the first block is taken and stored in the first memory 151. This storage is carried out up to the third divided period (see “A” in FIG. 4).

In the first divided period and a second divided period in the first frame period, black writing signals are sent to the pixels corresponding to the first block, and black writing is carried out (see “E” in FIG. 4).

Subsequently, in the second divided period in the first frame period, the luminance of the backlight and the gamma value are calculated from the video signals to be displayed in the first block (see “B” in FIG. 4).

Subsequently, in a third divided period in the first frame period, the video signals applied data processing as described above are written in the respective pixels. The pixels to be written are written to the respective pixels which belong to the range of the first block (see “C” in FIG. 4).

Subsequently, in a fourth divided period in the first frame period, the video signals written in a manner as described above are maintained, and the LEDs 112 of the backlight 11 corresponding to the first block are illuminated, so that an image is displayed (see “D” in FIG. 4).

Finally, in a fifth divided period in the first frame period, the LEDs 112 of the backlight 11 corresponding to the first block are extinguished, and black writing to the pixels corresponding to the first block is carried out again (see “E” in FIG. 4).

Subsequently, the second block will be described.

In the second block, the same process as in the first block is carried out with time corresponding to the first divided period behind the first block.

In other words, in the second divided period in the first frame period, the video signals are stored in the second memory 152 (see “A” in FIG. 4).

In the first divided period to the third divided period in the first frame period, the black writing signals are sent to the pixels corresponding to the second block to carry out black writing (see “E” in FIG. 4).

In the third divided period of the first frame period, the data processing is carried out in the same manner (see “B” in FIG. 4).

In the fourth divided period in the first frame period, the video signals are written into the pixels in the second block (see “C” in FIG. 4).

In the fifth divided period in the first frame period, the written video is held and causes the LEDs 112 of the backlight 11 corresponding to the second block to be illuminated.

Subsequently, in the third block, the same process is carried out with one divided period behind the second block. However, the memory to be used for storing the video signals in this case is the third memory 153.

Subsequently, in the fourth block as well, the same process is carried out with one divided period behind the third block. However, the memory to be used for storing the video signals corresponding to the fourth block in this case is the first memory 151. In other words, since the period to store the video signals in the fourth block is the fourth divided period in the first frame period, the video signals which are stored in the first memory 151 in the first block is already subjected to the data processing and written and hence they are no longer necessary in the first block, so that the video signals in the fourth block are stored.

Subsequently, in the fifth block, the same process is carried out with one divided period behind the fourth block. However, the memory to be used for storing in this case is the second memory 152 because the data processing of the video signals in the second block is already ended.

When the driving method as described above is carried out, since the frame memory for storing the video signals for one frame period as in the related art is no longer necessary, three memories for storing the video signals in each block must simply be prepared, so that the capacity of the memory may be reduced significantly.

Since the one frame period is divided into the five blocks and the flashingless driving method is carried out for each block, the flash phenomenon due to delay of the frame does not occur. In other words, since the video signals to be displayed and the luminance of the backlight match in one frame period, abnormal video signals with flickering or delayed luminance change due to the luminance of the backlight are not displayed.

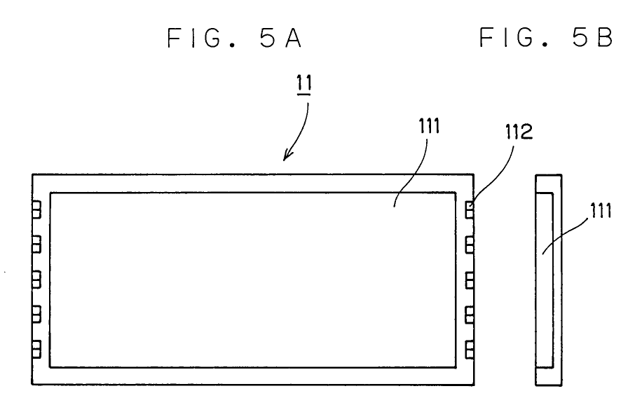

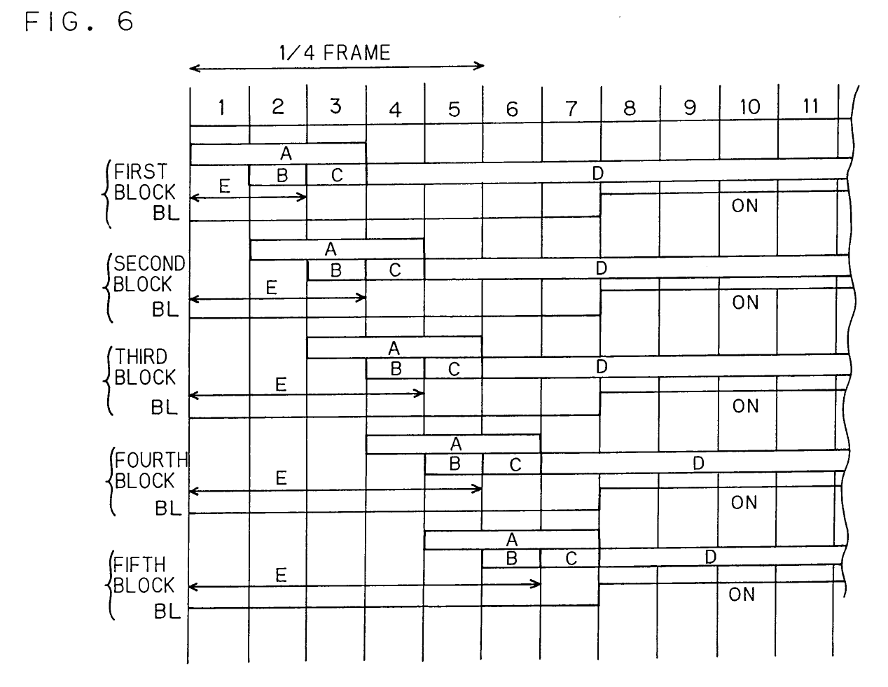

Referring now to FIGS. 5A, 5B and FIG. 6, a second liquid crystal display apparatus will be described.

The first different point of the second embodiment from the first embodiment is that while the five sets of LEDs 112 are provided in the backlight 11 for illuminating the blocks independently in the first embodiment, the backlight 11 which enables to illuminate and extinguish in all the areas at once is provided as shown in FIGS. 5A and 5B in the second embodiment. However, the display area is divided into five blocks as in the first embodiment.

The second different point is that while the black writing period, the video writing period and the video holding period are provided using the one frame period entirely in the first embodiment, writing process of the video signals in the blocks from the first block to the fifth block is carried out in ¼0 frame period in one frame period as shown in FIG. 6 in the second embodiment.

As shown in FIG. 6, the one frame period is divided into twenty divided periods.

Then, in the first block, the video signals are written from the first divided period to the third divided period, and periods from a fourth divided period onward are used as the video holding period.

Subsequently, in the second block, the video signals are written from the second divided period to the fourth divided period, and periods from a fifth divided period onward are used as the video holding period in the same manner.

Subsequently, in the third block, the video signals are written from the third divided period to the fifth divided period, and periods from a sixth divided period onward are used as the video holding period.

Subsequently, in the fourth block, the video signals are written from the fourth divided period to the sixth divided period, and periods from a seventh divided periods onward are used as the video holding period.

Subsequently, in the fifth block, the video signals are written from the fifth divided period to the seventh divided period, and periods from an eighth divided periods onward are used as the video holding period.

Finally, the backlight 11 is illuminated during periods from the eighth divided period onward until the end of this frame period.

Accordingly, the backlight 11 is illuminated from the eight divided period onward, and the luminance of the backlight may be increased.

In the same manner as in the first embodiment, the capacity of the memory may be reduced.

Also, abnormal video with flickering or delayed luminance change due to the luminance of the backlight is not displayed.

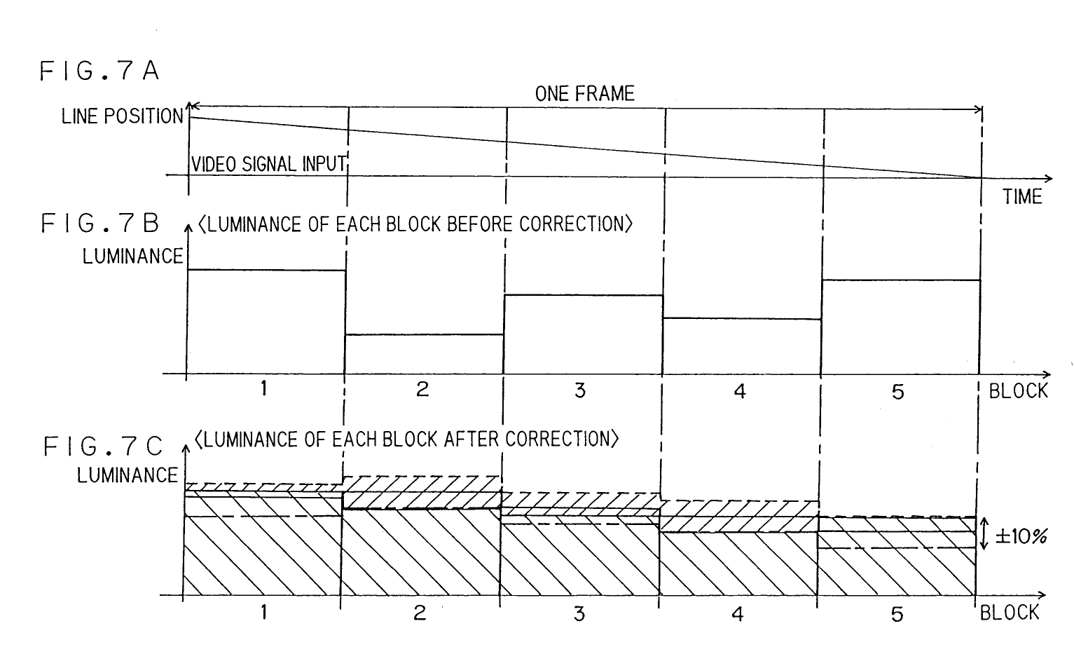

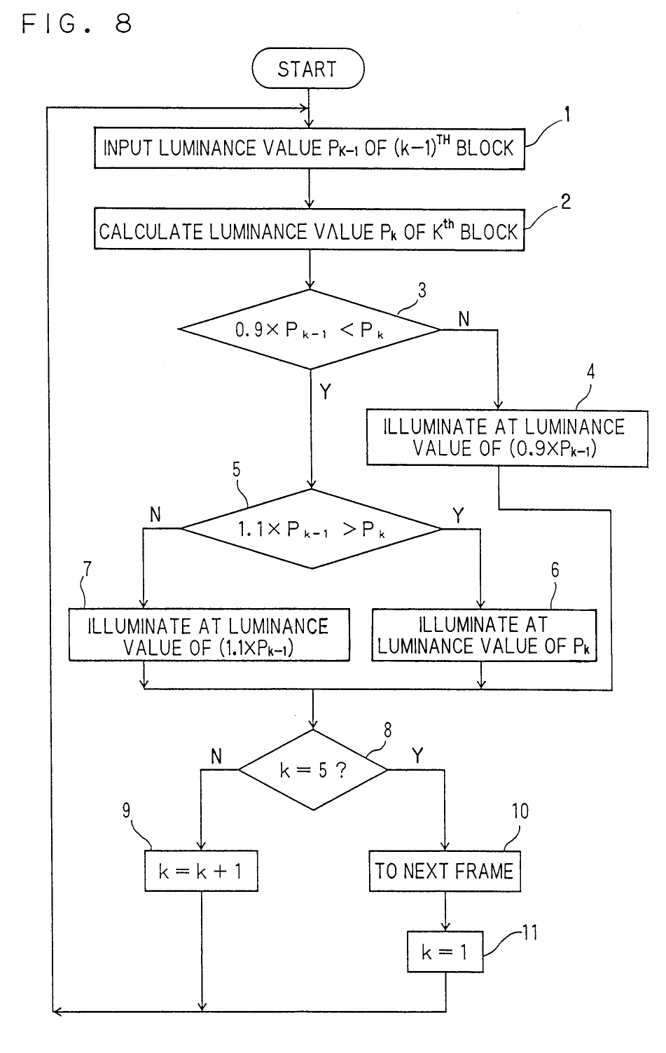

Referring now to FIG. 7 and FIG. 8, the liquid crystal display apparatus according to a third embodiment will be described.

In the liquid crystal display apparatus in the first embodiment, the luminance of the LEDs 112 and the gamma value were determined for each block. In the method of controlling the luminance of the backlight 11 as described above, when the difference in luminance between adjacent blocks is increased, there may be a case in which lines are visualized at boundaries between the adjacent blocks.

Therefore, in the liquid crystal display apparatus in the third embodiment, the method of controlling the luminance of the backlight 11 so as to avoid generation of lines at the boundaries between the adjacent blocks is provided.

Referring to FIG. 7, the method of controlling the luminance in the third embodiment will be described while comparing with the method of controlling in the first embodiment.

A part (a) in FIG. 7 shows a state on input of the video signals in one frame period, in which the vertical axis represents the position of the line, and the lateral axis is the time axis.

A part (b) in FIG. 7 shows a method of adjusting the luminance in the first embodiment, and the respective luminances are determined independently for five blocks. However, with the method of independently controlling the luminance of the blocks as described above, the difference in luminance between blocks as described above increases and, for example, in the part (b) in FIG. 7, the difference in luminance between the first block and the second block increases, so that there is a case in which the line is visualized at the boundary between the first block and the second block in the liquid crystal panel 10.

A part (c) in FIG. 7 shows the luminances in the respective blocks in the third embodiment.

The second block is specifically described. When the luminance of the second block is calculated in the method of calculating according to the first embodiment, values as shown in the part (b) in FIG. 7 are obtained. However, with these values, the difference from the luminance of the first block is increased, and hence the line may be visualized. Therefore, in the third embodiment, correction is carried out so as to make the luminance of the second block fall within a range of ±10% with respect to the luminance of the first block.

In this arrangement, the difference in luminance between adjacent blocks is reduced, so that the line is prevented from being generated between the blocks as described above.

Referring now to FIG. 8, a method of controlling the luminance of the backlight 11 according to the third embodiment will be described.

In Step 1, a luminance Pₖ₋₁ of a (k−1)^{th} block is entered. The luminance Pₖ₋₁ which is calculated in a block immediately before is used.

In Step 2, a luminance Pₖ in the k^{th} block is calculated. This calculating method is the same as the first calculating method.

In Step 3, the luminance Pₖ of the k^{th} block and a value of 90% of the luminance Pₖ₋₁ of the (k−1)^{th} block are compared, and when the luminance Pk of the k^{th} block is larger than 0.9×Pₖ₋₁, the procedure goes to Step 4 and, when it is smaller, the procedure goes to Step 5.

In Step 4, since the luminance Pₖ of the k^{th} block is smaller than 90% of the luminance Pₖ₋₁ of the block immediately before, the luminance is corrected to a value of 90% of the luminance Pₖ₋₁ of the (k−1)^{th} block and the backlight 11 is illuminated at the corrected luminance. The corrected luminance is used to correct the gamma value. Then, the procedure goes to Step 8.

In Step 5, a value of 110% of the luminance Pₖ₋₁ of the (k−1)^{th} block and the luminance Pₖ₋₁ of the k^{th} block are compared and, when the luminance Pₖ of the k^{th} block is smaller than 1.1×Pₖ₋₁, the procedure goes to Step 6 and, when it is larger, the procedure goes to Step 7.

In Step 6, since the luminance Pₖ of the k^{th} block is within a range of ±10% of the luminance Pₖ₋₁ of the (k−1)^{th} block, the backlight is illuminated at the luminance Pₖ of the k^{th} block. The gamma value is corrected using this luminance. Then, the procedure goes to Step 8.

In Step 7, since the luminance Pₖ of the k^{th} block is larger than 110% of the luminance Pₖ₋₁ of the (k−1)^{th} block, the luminance is collected to a value of 110% of the luminance Pₖ₋₁ of the (k−1)^{th} block and the backlight 11 is illuminated at the corrected luminance. The corrected luminance is used to correct the gamma value. Then, the procedure goes to Step 8.

In Step 8, whether k=5 or not is determined, that is, when the procedure is not carried out all the way through the last block, the procedure goes to Step 9, and if carried out, the procedure goes to Step 10.

In Step 9, the procedure goes back to Step 1 with k=k+1.

Proceeding to the next step in Step 10, the procedure goes back to Step 1 with k=1 in Step 11. When having proceeded to the next frame, the luminance of the last block of the frame immediately before is used as the luminance Pₖ₋₁ of the (k−1)^{th} block in Step 1.

Since the luminance is compared with the luminance of the block immediately before, and the luminance of the next block is adjusted to fall within ±10% of the luminance of the block immediately before, generation of the lines between the adjacent blocks is avoided.

In the above-described embodiment, the luminance of the current block is set to ±10% of the luminance of the block immediately before. However, the value may be values larger than ±10% or smaller than ±10% instead as long as the lines are not visualized at the boundaries between adjacent blocks.

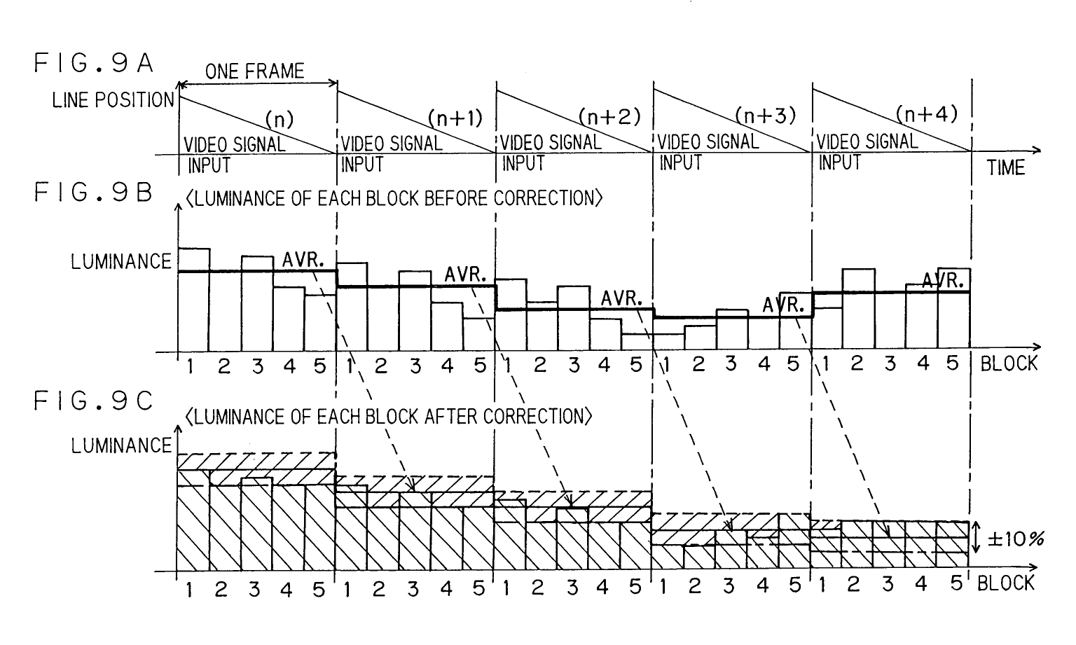

Referring now to FIG. 9, a fourth embodiment will be described.

In the third embodiment, in order to prevent the lines at the boundaries between adjacent blocks from being visualized, the luminance is determined with respect to the luminance of the block immediately before. However, in the fourth embodiment, the luminance is determined with respect to an average value of the luminance values in the respective blocks in the frame immediately before the current frame.

A part (a) in FIG. 9 represents the input of the video signals and the line position in each frame.

A part (b) in FIG. 9 represents the state of luminance for each frame described in the first embodiment. In this state, as described in the second embodiment, there is a case in which lines may be generated between adjacent blocks.

As shown in FIG. 9(c), an average value of the luminance of the respective blocks in the frame immediately before the current frame calculated by the backlight luminance calculator 34 (hereinafter, referred to as “luminance candidate” in the fourth embodiment) is obtained. Then, the luminance candidates of the respective blocks of the next frame calculated by the backlight luminance calculator 34 are corrected so that the luminance of the each block in the next frame falls within ±10% of the average value of the luminance candidates, and the backlight is illuminated at the corrected luminance.

With the control as described above, lines at the boundaries between blocks are prevented from being generated.

The luminance candidates are not limited to ±10% of the average of the luminance values of the respective blocks in all the frames, and may be values larger than ±10% or values smaller than ±10% as long as lines are not visible at the boundaries between adjacent blocks.

The invention is not limited to the embodiments shown above, and various modifications may be made without departing from the scope of the invention.

Although the case in which the area extending in the lateral direction is divided into five blocks has been described in the above-described embodiments, division into two or more blocks is applicable, and division into 10 or more blocks, for example, into 15 to 20 blocks may also be applicable.

In the embodiments shown above, the OCB-type liquid crystal display apparatus has been described. However, the embodiments may be applied to the liquid crystal display apparatus of TN-type, VA-type, IPS-type, ferroelectric type, or antiferroelectric type.

As the speed of response of the liquid crystal described above, for example, 5 milliseconds or lower, in particular, when writing non-video signals, the liquid crystal of OCB-type is preferable.

In the first and second embodiments, the flashingless driving is carried out for each block in sequence from the top. However, the invention is not limited thereto, and the flashingless driving may be carried out for each block in sequence from the bottom, or at random from block-to-block basis.

What is claimed is:

1. A liquid crystal display apparatus comprising:
a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;
a backlight illuminating the liquid crystal panel;
a source driver outputting video signals and non-video signals to the respective signal lines;
a gate driver outputting gate signals to the respective scanning lines;
a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order; and
a second control unit controlling illumination and extinction of the backlight, and illuminating the backlight for each block and during the video holding period in each block.

2. The liquid crystal display apparatus according to claim 1, further comprising S block memories (where 1<S<L) storing the video signals for the each block,
wherein the video signals stored in the block memories are outputted to the first control unit.

3. The liquid crystal display apparatus according to claim 1, wherein the non-video signals are signals corresponding to a black display.

4. The liquid crystal display apparatus according to claim 1, wherein the liquid crystal panel is an OCB-type liquid crystal.

5. A liquid crystal display apparatus comprising:
a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;
a backlight illuminating the liquid crystal panel;
a source driver outputting video signals and non-video signals to the respective signal lines;
a gate driver outputting gate signals to the respective scanning lines;
a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order, and controlling each block to have the non-video signal writing period, the video writing period and the video holding period in this order; and
a second control unit controlling illumination and extinction of the backlight.

6. The liquid crystal display apparatus according to claim 5, further comprising S block memories (where 1<S<L) which store the video signals for the each block,
wherein the video signals stored in the block memories are outputted to the first control unit.

7. The liquid crystal display apparatus according to claim 5, wherein the non-video signals are signals corresponding to a black display.

8. The liquid crystal display apparatus according to claim 5, wherein the liquid crystal panel is an OCB-type liquid crystal.

9. A liquid crystal display apparatus comprising:
a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;
a backlight illuminating the liquid crystal panel;
a source driver outputting video signals and non-video signals to the respective signal lines;
a gate driver outputting gate signals to the respective scanning lines;
a first control unit controlling the non-video signals to have a non-video signal writing period in which the non-video signals are written in the respective pixels, a video writing period in which the video signals are written in the respective pixels, and a video holding period in which the video signals written in the respective pixels are held in sequence in one frame period in this order; and
a second control unit controlling illumination and extinction of the backlight,
wherein the first control unit
(1) controls the each block to have the non-video signal writing period, the video writing period and the video holding period in this order, and
(2) controls the video writing period of the k^{th} block (where 1<k<L) to be delayed with respect to the video writing period of the (k−1)^{th} block by a predetermined time period.

10. The liquid crystal display apparatus according to claim 9, further comprising S block memories (where 1<S<L) storing the video signals for the each block,
wherein the video signals stored in the block memories are outputted to the first control unit.

11. The liquid crystal display apparatus according to claim 9, wherein the backlight includes a light source for each block and
wherein the second control unit illuminates the each light source only in the video holding period of each block and extinguishes the same in other periods.

12. The liquid crystal display apparatus according to claim 9, wherein the one frame period includes the video writing period and the backlight illuminating period,
wherein the first control unit writes the non-video signals and the video signals during the signal writing period from the first block to the L^{th} block, and
wherein the second control unit illuminates the light source in the display area simultaneously with the beginning of the video holding period of the L^{th} block in the illuminating period and extinguishes the light source simultaneously with the ending of the one frame period.

13. The liquid crystal display apparatus according to claim 9, wherein the non-video signals are signals corresponding to a black display.

14. The liquid crystal display apparatus according to claim 9, wherein the liquid crystal panel is an OCB-type liquid crystal.

15. A liquid crystal display apparatus comprising:
a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;
a backlight illuminating the liquid crystal panel and including a light source for the each block;
a source driver outputting video signals and non-video signals to the respective signal lines;
a gate driver outputting pulsed gate signals to the respective scanning lines;
a first control unit controlling the non-video signals so as to have a non-video signal writing period in which the non-video signals are written in the respective pixels, a video writing period in which the video signals are written in the respective pixels, and a video holding period in which the video signals written in the respective pixels are held in sequence in this order, the first control unit (1) controlling the each block to have the non-video signal writing period, the video writing period and the video holding period in this order, and (2) controlling the video writing period of the k^{th} block (where 1<k≦L) to be delayed with respect to the video writing period of the (k−1)^{th} block by a predetermined time period; and
a second control unit controlling illumination and extinction of the backlight, the second control unit (1) correcting the luminance of the light source of the k^{th} block within a predetermined range of the luminance of the light source of the (k−1)^{th} block, and (2) illuminating the respective light sources at the corrected luminance only in the video holding period of each block and extinguishes the same during other periods.

16. The liquid crystal display apparatus according to claim 15, further comprising S block memories (where 1<S<L) storing the video signals for the each block,
wherein the video signals stored in the block memories are outputted to the first control unit.

17. The liquid crystal display apparatus according to claim 15, wherein the second control unit corrects the luminance of the light source in the k^{th} block into a luminance within a range of ±10% of the luminance of the light source in the (k−1)^{th} block.

18. The liquid crystal display apparatus according to claim 15, wherein the non-video signals are signals corresponding to a black display.

19. The liquid crystal display apparatus according to claim 15, wherein the liquid crystal panel is an OCB-type liquid crystal.

20. A liquid crystal display apparatus comprising:
a liquid crystal panel having m signal lines extending in the vertical direction, n scanning lines extending in the lateral direction and a plurality of pixels arranged in a matrix pattern in a display area which is divided into blocks from a first block to an L^{th} block (where 1<L<n) extending in the lateral direction;
a backlight illuminating the liquid crystal panel and including a light source for each block;
a source driver outputting video signals and non-video signals to the respective signal lines;
a gate driver outputting pulsed gate signals to the respective scanning lines;
a first control unit controlling, in each block, the non-video signals to have a non-video signal writing period in which the non-video signals are written in the respective pixels, a video writing period in which the video signals are written in the respective pixels, and a video holding period in which the video signals written in the respective pixels are held in sequence in one frame period in this order; and
a second control unit controlling illumination and extinction of the backlight, the second control unit (1) calculating the luminance of the each light source for each frame period on the basis of the video signals, (2) correcting the luminance of the each light source in the current frame period into a luminance included in a predetermined range of an average value of the luminance of the each light source in one frame period before the current frame period, and (3) illuminating the each light source at the corrected luminance only in the video holding period of each block and extinguishes the same in other periods.

21. The liquid crystal display apparatus according to claim 20, further comprising S block memories (where 1<S<L) storing the video signals for the each block,
wherein the video signals stored in the block memories are outputted to the first control unit.

22. The liquid crystal display apparatus according to claim 20, wherein the non-video signals are signals corresponding to a black display.

23. The liquid crystal display apparatus according to claim 20, wherein the liquid crystal panel is an OCB-type liquid crystal.
